(19) United States
(12) Patent Application Publication
(10) Pub. No.: US 2024/0375610 A1
(43) Pub. Date: Nov. 14, 2024

(54) DEVICE AND METHOD FOR AUTHENTICATING AN AUTHORISATION OF A PERSON TO USE A VEHICLE

(71) Applicant: MERCEDES-BENZ GROUP AG, Stuttgart (DE)

(72) Inventor: Konrad BETZ, Stuttgart (DE)

(21) Appl. No.: 18/287,313

(22) PCT Filed: Feb. 9, 2022
(86) PCT No.: PCT/EP2022/053079

§ 371 Date: Oct. 18, 2023

(30) Foreign Application Priority Data
Apr. 20, 2021 (DE) 10 2021 002 073.1

(51) Int. Cl. B60R 25/24; H04W 76/14

(52) U.S. Cl. CPC B60R 25/24; H04W 76/14; B60R 2325/101; B60R 2325/205

(57) ABSTRACT

Authenticating an authorization of a person to use a vehicle, involves forming a Bluetooth radio link between a handset and exactly one of several nodes coupled with a control unit and forming an ultra-wideband, close-range radio link between the handset and the control unit. The control unit authenticates the handset as authorized when an authorization transmitted from the handset via the Bluetooth radio link is recognized and a position of the handset is determined using a communication with the handset via the ultra-wideband close-range radio link. Depending on the handset position, connection qualities of possible Bluetooth radio links between the handset and the nodes are determined. If a Bluetooth radio link to one of the nodes has a higher connection quality than a currently formed Bluetooth radio link to an activated node, the activated node is deactivated and the node with the higher connection quality is activated to form the Bluetooth radio link.

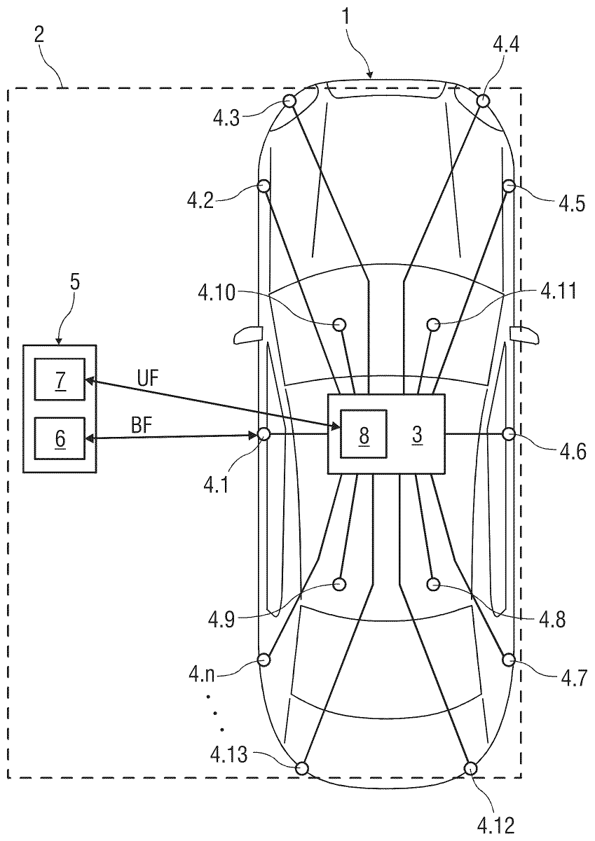

### BACKGROUND AND SUMMARY OF THE INVENTION

Exemplary embodiments of the invention relate to a device for authenticating an authorization of a person to use a vehicle, as well as to a method for authenticating an authorization of a person to use a vehicle.

EP 1 467 322 A2 discloses a motor vehicle door locking system having a motor vehicle lock, designed such that it can be unlocked and locked by a motor and can also be opened by a motor. A control device in the vehicle and a handset carried by the operating person are provided, wherein the control device and the handset are respectively equipped with communication electronics and a bi-directional radio link between the control device and the handset can be formed. A system function of the motor vehicle door locking system can be triggered by the handset via the radio link. The radio link between the control device and the handset is a radio link according to the Bluetooth industry standard. The system functions that can be triggered by the handset are unlocking the motor vehicle lock and opening the motor vehicle lock with a motor.

DE 10 2015 208 621 A1 discloses a location device for locating an object, the location device is designed to select one of several location technologies depending on the distance of the object to be located from a motor vehicle. The location technologies include an UWB broadband transmission.

Exemplary embodiments of the invention are directed to a method and a device that are improved in relation to the prior art for authenticating an authorization of a person to use a vehicle.

The device according to the invention for authenticating an authorization of a person to use a vehicle comprises a control unit in the vehicle, the control unit being coupled with several nodes that are respectively designed as a Bluetooth interface and are, or can be, arranged spaced apart from one another on or in the vehicle. The device further comprises a portable handset having a Bluetooth interface, which is designed to form a Bluetooth radio link with exactly one of the nodes at any time, the Bluetooth radio link being, in particular, bi-directional and designed according to the Bluetooth industry standard. The handset and the control unit additionally respectively comprise an ultra-wideband interface for forming an ultra-wideband close-range radio link, which is, in particular, designed to be bi-directional. The control unit is designed to authenticate the handset as authorized when it recognizes an authorization transmitted from the handset via the Bluetooth radio link, and to determine a position of the handset using a communication carried out with the handset via the ultra-wideband close-range radio link. The control unit is further designed, depending on the position of the handset, to determine connection qualities of possible Bluetooth radio links between the handset and the nodes, and if a Bluetooth radio link to one of the nodes has a higher connection quality than a currently formed Bluetooth radio link to an activated node, to deactivate the node currently activated for this Bluetooth radio link and to activate the node provided to form the Bluetooth radio link with the higher connection quality.

The handset, in particular, forms a digital vehicle key. The nodes of the control unit positioned in and/or on the vehicle, for example on bumpers, enable an uninterrupted Bluetooth radio coverage in and around the vehicle. If a vehicle user approaches with the handset, the latter connects with any node, wherein shadowing effects can be caused by the vehicle due to a movement of the handset relative to the vehicle and/or in the vehicle and thus relative to the nodes, which shadowing effects can impair the Bluetooth radio link between the handset and the control unit. Due to the monitoring of the connection quality, it is possible to deactivate the current node by means of the present device in a particularly advantageous manner before or immediately when such impairments arise and to activate another node, to which a Bluetooth radio link with a higher connection quality can be formed. This active deactivation and activation prevents a break in the connection between the handset and the control unit resulting from shadowing, and consequently so-called supervision timeouts, which could lead to a duration of up to 20 seconds being required until a new radio connection between the handset and a node is formed. The device enables an interruption time of the Bluetooth radio link between the handset and the control unit to be kept to a minimum by active deactivation and activation, such that the use of the vehicle, in particular an access to the interior of the vehicle and a start of the engine, can be at least almost continuously ensured for a vehicle user. Longer waiting times can thus be avoided.

In a possible embodiment of the device, the Bluetooth interface of the handset and the nodes are designed to form a Bluetooth radio link according to the Bluetooth low-energy industry standard. Bluetooth low energy, also described as Bluetooth LE or BLE for short, is understood to mean radio technology with which devices in an environment of approximately ten meters can be interconnected. In comparison with a radio link or radio connection according to the “classic” Bluetooth industry standard, BLE is characterized by a significantly lower energy consumption and significantly lower costs at a similar communication range.

In a further possible embodiment of the device, the handset is a mobile device such as a smartphone, a so-called smartwatch, or a so-called wearable computer, described as a wearable for short. Such a design of the handset means that no separate vehicle key is required, and instead functions of the latter can be carried out on a mobile device that a vehicle user usually or always carries with them.

In the method according to the invention for authenticating an authorization of a person to use a vehicle, a Bluetooth radio link, which is designed, in particular, to be bi-directional and according to the Bluetooth industry standard is formed between a portable handset and exactly one of several nodes that are respectively designed as a Bluetooth interface, arranged spaced apart from one another on and/or in the vehicle and coupled with a control unit. In addition, an ultra-wideband close-range radio link that is, in particular, designed to be bi-directional is formed between the handset and the control unit. By means of the control unit, the handset is authenticated as authorized when an authorization transmitted from the handset via the Bluetooth radio link is recognized, and a position of the handset is determined using a communication carried out with the handset via the ultra-wideband close-range radio link. Depending on the position of the handset, connection qualities of possible Bluetooth radio links between the handset and the nodes are determined by means of the control unit. If a Bluetooth radio link to one of the nodes has a higher connection quality than a currently formed Bluetooth radio link to an activated node, then by means of the control unit, the node currently activated for this Bluetooth radio link is deactivated and the node provided to form the Bluetooth radio link with the higher connection quality is activated.

Due to the monitoring of the connection quality, it is possible to deactivate the current node by means of the present method in a particularly advantageous manner before or immediately when an impairment of the Bluetooth radio link arises and to activate another node, to which a Bluetooth radio link with a higher connection quality can be formed. This active deactivation and activation prevents a break in the connection between the handset and the control unit resulting from shadowing, and consequently so-called supervision timeouts, which could lead to a duration of up to 20 seconds being required until a new radio connection between the handset and a node is formed. The method enables an interruption time of the Bluetooth radio link between the handset and the control unit to be kept to a minimum by active deactivation and activation, such that the use of the vehicle, in particular an access to the interior of the vehicle and a start of the engine, can be at least almost continuously ensured for a vehicle user. Longer waiting times can thus be avoided.

Exemplary embodiments of the invention are explained in more detail in the following with reference to a drawing.

### BRIEF DESCRIPTION OF THE DRAWING FIGURE

Here:

The sole FIGURE schematically shows an aerial view of a vehicle and a device for authenticating an authorization of a person to use the vehicle.

### DETAILED DESCRIPTION

The sole figure illustrates an aerial view of a vehicle 1 and a device 2 for authenticating an authorization of a person to use the vehicle 1. The vehicle 1 can be a component of the device 2.

The device 2 is designed to provide a keyless access and authorization system and comprises a control unit 3 in the vehicle, the control unit being coupled with several nodes 4.1 to 4.n. The nodes are respectively designed as a Bluetooth interface, in particular according to the Bluetooth low-energy industry standard, and are arranged spaced apart from one another on the vehicle 1, for example on bumpers, and in the vehicle 1.

The device 2 further comprises a portable handset 5 having a Bluetooth interface 6. The handset 5 is designed to form a Bluetooth radio link BF with exactly one of the nodes 4.1 to 4.n at any time. For example, the handset 5 is a mobile device, e.g., a smartphone, a so-called smartwatch, or a so-called wearable computer. The handset 5 can also be designed as a conventional electronic vehicle key as a separate component.

The handset 5 and the control unit 3 further additionally respectively comprise an ultra-wideband interface 7, 8 for forming an ultra-wideband close-range radio link UF.

If a vehicle user approaches the vehicle 1 with the handset 5, the handset 5 connects to one of the nodes 4.1 to 4.n via the Bluetooth radio link BF, in the depicted exemplary embodiment, for example, to the node 4.1. An authorization is transmitted to the control unit 3 via the Bluetooth radio link BF, the control unit authenticating the handset 5 as authorized when this authorization is correctly received. If the Bluetooth radio link BF, and consequently the authentication, are active, it is possible for the vehicle user to unlock the vehicle 1, for example by touching a touch-sensitive surface, and thus to have access to the vehicle interior. After entering the vehicle interior while the Bluetooth radio link BF is active, and consequent active authentication, it is also possible for the vehicle user to start the vehicle 1.

To avoid the Bluetooth radio link BF being interrupted due to shadowing arising when the vehicle user with the handset 5 moves relative to the vehicle 1, and subsequently a longer period of time for connecting the handset 5 to one of the nodes 4.1 to 4.n being required, for example due to a so-called supervision timeout, a position of the handset 5 is determined by means of the control unit 3 using a communication carried out with the handset 5 via the ultra-wideband close-range radio link UF.

Depending on the position of the handset 5, the control unit 3 determines connection qualities of possible Bluetooth radio links BF between the handset 5 and the nodes 4.1 to 4.n. If the control unit 3 determines that a Bluetooth radio link BF to one of the nodes 4.1 to 4.n has a higher connection quality than a currently formed Bluetooth radio link BF to an activated node 4.1 to 4.n, the control unit deactivates the node 4.1 to 4.n currently activated for this Bluetooth radio link BF and activates the node 4.1 to 4.n provided to form the Bluetooth radio link BF with the higher connection quality. If, for example, the control unit 3 determines in the depicted exemplary embodiment that the connection quality with the active node 4.1 is lower than a possible connection quality with the node 4.2, said control unit deactivates the node 4.1 and activates the node 4.2, such that a new Bluetooth radio link BF is formed between the handset 5 and the node 4.2.

This means that the control unit 3 can end a current Bluetooth radio link BF in a targeted and active manner with a location result determined using the ultra-wideband close-range radio link UF if another node 4.1 to 4.n enables a better connection quality. The control unit 3 can thus control which new node 4.1 to 4.n should form the new Bluetooth radio link BF to the handset 5 by controlling the nodes 4.1 to 4.n via targeted control depending on the location result. When the Bluetooth radio link BF is ended actively in such a way, a new Bluetooth radio link BF to another node 4.1 to 4.n can be formed very quickly.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-4. (canceled)

5. A system for authenticating an authorization of a person to use a vehicle, the device comprising:
a control unit, in the vehicle, coupled with a plurality of nodes, wherein the control unit comprises an ultra-wideband interface configured to form an ultra-wideband, close-range radio link, wherein each of the plurality of nodes is configured as a Bluetooth interface, and each of the plurality of nodes are arranged spaced apart from one another on or in the vehicle;
a portable handset comprising a Bluetooth interface configured to form a Bluetooth radio link with exactly one of the plurality of nodes at any given time and an ultra-wideband interface configured to form the ultra-wideband, close-range radio link,
wherein the control unit is configured
to authenticate the portable handset as authorized when the control unit recognizes an authorization transmitted from the portable handset via the Bluetooth radio link,
to determine a position of the portable handset using a communication with the portable handset via the ultra-wideband, close-range radio link,
to determine, depending on the position of the portable handset, connection qualities of possible Bluetooth radio links between the handset and the plurality of nodes, and
when the determined connection qualities of one of the possible Bluetooth radio links has a higher connection quality than a currently formed Bluetooth radio link to an activated one of the plurality of nodes, to deactivate the activated one of the plurality of nodes and to activate one of the plurality of nodes having the higher connection quality to form the Bluetooth radio link.

6. The system of claim 5, wherein the Bluetooth interfaces of the portable handset and the plurality of nodes are configured the Bluetooth radio link according to the Bluetooth low-energy industry standard.

7. The system of claim 5, wherein the portable handset is a mobile device.

8. A method for authenticating an authorization of a person to use a vehicle, the method comprising:
forming a Bluetooth radio link between a portable handset and exactly one of a plurality of nodes that are respectively configured as a Bluetooth interface and arranged spaced apart from one another on or in the vehicle and coupled with a control unit;
forming an ultra-wideband, close-range radio link is additionally formed between the portable handset and the control unit;
authenticating, by the control unit, the portable handset is as authorized when an authorization transmitted from the portable handset via the Bluetooth radio link is recognized;
determining, by the control unit, a position of the portable handset using a communication with the portable handset via the ultra-wideband, close-range radio link;
determining, by the control unit depending on the position of the portable handset, connection qualities of possible Bluetooth radio links between the portable handset and the plurality of nodes; and
deactivating, by the control unit responsive to one of the possible Bluetooth radio links having a higher connection quality than a currently formed Bluetooth radio link, a currently activated one of the plurality of nodes and activating one of the plurality of nodes having the higher connection quality to form the Bluetooth radio link.
